(19) United States
(12) Patent Application Publication
(10) Pub. No.: US 2010/0103157 A1
(43) Pub. Date: Apr. 29, 2010

(54) LIQUID CRYSTAL DISPLAY DRIVE CIRCUIT

(75) Inventors: Kensuke Goto, Ashikaga-Shi (JP); Tetsuya Tokunaga, Ora-Gun (JP); Norikazu Katagiri, Ora-gun (JP)

Correspondence Address: MORRISON & FOERSTER LLP, 1650 TYSONS BOULEVARD, SUITE 400, MCLEAN, VA, 22102, US

(73) Assignees: SANYO Electric Co., Ltd., Moriguchi-shi (JP); SANYO Semiconductor Co., Ltd., Ora-gun (JP)

(21) Appl. No.: 12/604,779

(22) Filed: Oct. 23, 2009

(30) Foreign Application Priority Data
Oct. 26, 2008 (JP) 2008-274548

(51) Int. Cl. G09G 5/00; G09G 3/36

(52) U.S. Cl. 345/211; 345/87

(57) ABSTRACT

A liquid crystal display drive circuit that suppresses a pulse noise in a liquid crystal display panel without increasing a mounting area is offered. A common signal COMi is varied in a staircase waveform with an increment of 1/3 VLCD in such a way that a high electric potential VLCD→a first intermediate electric potential VLCD1→a second intermediate electric potential VLCD2→a low electric potential VSS, when the common signal COMi varies by the maximum amplitude, in other words, when the common signal COMi makes a transition from the high electric potential VLCD to the low electric potential VSS. The segment signal SEGj is varied similarly in a staircase waveform in such a way that the low electric potential VSS→the second intermediate electric potential VLCD2→the first intermediate electric potential VLCD1→the high electric potential VLCD when the segment signal SEGj makes a transition from the low electric potential VSS to the high electric potential VLCD. A peak value of the pulse noise due to a capacitive coupling can be reduced to 1/3 of that in the prior art.

### CROSS-REFERENCE OF THE INVENTION

This application claims priority from Japanese Patent Application No. 2008-274548, the content of which is incorporated herein by reference in its entirety.

### BACKGROUND OF THE INVENTION

1. Field of the Invention

This invention relates to an LCD (Liquid Crystal Display) drive circuit that outputs segment signals and common signals to turn LCD segments on or off.

2. Description of the Related Art

In general, a segment type LCD (liquid crystal display) panel displays images by applying common signals and segment signals to common electrodes and segment electrodes, respectively. Each of the common signals repeats a certain waveform pattern. On the other hand, each of the segment signals has an arbitrary waveform pattern that corresponds to display data. Displaying the image is controlled by turning on/off of liquid crystal interposed between the common electrode and the segment electrode in response to electric field generated between the common electrode and the segment electrode corresponding to the common signal and the segment signal.

FIG. 10 shows a structure of an LCD panel 12 having four common signals COM1-COM4. The LCD panel 12 is provided with four common electrodes, each of which is provided with n (50, for example) segment electrodes facing to it. Liquid crystal LC is interposed between each of the common electrodes and the n segment electrodes. Each of the common signals COM1-COM4 is applied to corresponding each of the four common electrodes, while each of the segment signals SEG1-SEGn is applied to corresponding each of the n segment electrodes.

FIG. 11 is a waveform diagram showing the common signals COM1-COM4 and an example of a segment signal SEGj in 1/4 duty 1/3 bias driving mode (j represents any integer between 1 and n inclusive). Each of the common signals COM1-COM4 shows the certain waveform pattern made of four electric potentials that are a high electric potential VLCD (power supply electric potential), a low electric potential VSS (ground electric potential=0 V), a first intermediate electric potential (=2/3 VLCD) and a second intermediate electric potential (=1/3 VLCD). Each of the common signals COM1-COM4 is shifted in phase from a preceding one of the common signals COM1-COM4 by a quarter period of the waveform pattern. Although the segment signal SEGj is also made of the four electric potentials, its waveform pattern is arbitrarily defined by the display data.

In the case of the segment signal SEGj shown in FIG. 11, a segment j corresponding to the common signal COM3 is turned on only for duration shown in the drawing. It is because an electric potential difference between the common signal COM3 and the segment signal SEGj becomes a high enough voltage VLCD for the duration to turn the liquid crystal LC on. The segment j is turned off during the rest of the period since an electric potential difference between any of the common signals COM1-COM4 and the segment signal SEGj does not reach VLCD and the liquid crystal LC is not turned on.

It should be noted that the common signals COM1-COM4 and the segment signal SEGj are alternating signals. That is, VLCD and VSS are outputted alternately in the turned-on duration, while the two intermediate electric potentials are outputted alternately in the turned-off duration. It is because burn-in is caused in the liquid crystal LC, if a direct current bias is applied to the liquid crystal LC for a long time.

FIG. 12 shows a structure of an LCD drive circuit that generates a common signal COMi and the segment signal SEGj in the 1/3 bias driving mode. The common signal COMi is any one of the four common signals COM1-COM4 in the case of the 1/4 duty driving mode, and the segment signal SEGj is any one of the n segment signals SEG1-SEGn.

A first bias resistor VR1, a second resistor VR2 and a third bias resistor VR3 are connected in series between the high electric potential VLCD and the low electric potential VSS so as to generate the first intermediate electric potential VLCD1 (=2/3 VLCD) and the second intermediate electric potential VLCD2 (=1/3 VLCD). The high electric potential VLCD, the low electric potential VSS, the first intermediate electric potential VLCD1 and the second intermediate electric potential VLCD2 are inputted to a common signal output circuit 10 and a segment signal output circuit 11. The common signal output circuit 10 outputs the common signal COMi, while the segment signal output circuit 11 outputs the segment signal SEGj. The common signal COMi and the segment signal SEGj are applied to the LCD panel 12 as shown in FIG. 10. This kind of LCD drive circuit is disclosed in Japanese Patent Application Publication No. H09-197366, for example.

In some cases, however, there appears a whisker-like pulse noise and there is caused a display failure when the common signal COMi or the segment signal SEGj varies, because the common electrode to which the common signal COMi is applied and the segment electrode to which the segment signal SEGj is applied are connected by capacitive coupling through the liquid crystal LC.

Thus, it is conceived that an external capacitor C1 is connected to a connecting node between the first bias resistor VR1 and the second bias resistor VR2 and another external capacitor C2 is connected to a connecting node between the second bias resistor VR2 and the third bias resistor VR3 as shown in FIG. 12 so that the pulse noise is absorbed. However, there is caused a problem that a mounting area is increased when the external capacitors C1 and C2 are mounted on a printed circuit board together with an IC (Integrate Circuit) that incorporates the LCD drive circuit.

### SUMMARY OF THE INVENTION

Principal features of an LCD drive circuit of this invention are as follows.

This invention provides an LCD drive circuit that operates in a 1/n (n is an integer equal to or larger than two.) bias driving mode to make a display on an LCD panel by outputting common signals to common electrodes of the LCD panel and outputting segment signals to segment electrodes of the LCD panel. The LCD drive circuit includes n bias resistors that are connected in series between a high electric potential and a low electric potential and generate (n−1) intermediate electric potentials between the high electric potential and the low electric potential, a common signal output circuit that outputs the common signals made of the high electric potential, the low electric potential and at least one of the (n−1) intermediate electric potentials, and a segment signal output circuit that outputs the segment signals made of the high electric potential, the low electric potential and at least one of the (n−1) intermediate electric potentials, wherein the common signal output circuit varies the common signals in a staircase waveform staying for a period at at least one of the (n−1) intermediate electric potentials when the common signals make a transition between the high electric potential and the low electric potential, and the segment signal output circuit varies the segment signals in a staircase waveform staying for a period at at least one of the (n−1) intermediate electric potentials when the segment signals make a transition between the high electric potential and the low electric potential.

This invention also provides another LCD drive circuit that operates in a 1/n (n is an integer equal to or larger than two.) bias driving mode to make a display on an LCD panel by outputting common signals to common electrodes of the LCD panel and outputting segment signals to segment electrodes of the LCD panel. The LCD drive circuit includes n bias resistors that are connected in series between a high electric potential and a low electric potential and generate (n−1) intermediate electric potentials between the high electric potential and the low electric potential, n boost resistors that are connected between the high electric potential and the low electric potential and generate the (n−1) intermediate electric potentials between the high electric potential and the low electric potential, a common signal output circuit that outputs the common signals made of the high electric potential, the low electric potential and at least one of the (n−1) intermediate electric potentials, a segment signal output circuit that outputs the segment signals made of the high electric potential, the low electric potential and at least one of the (n−1) intermediate electric potentials, and a switching circuit that outputs at least one of the (n−1) intermediate electric potentials generated by the n boost resistors to the common signal output circuit and the segment signal output circuit when the common signal or the segment signal varies.

### BRIEF DESCRIPTION OF THE DRAWINGS

FIG. 1 shows a structure of a 1/3 bias driving mode LCD drive circuit according to an embodiment of this invention.

FIG. 2 shows a structure of a 1/4 bias driving mode LCD drive circuit according to the embodiment of this invention.

FIG. 3 shows waveforms of output voltages from the 1/3 bias driving mode LCD drive circuit according to the embodiment of this invention.

FIG. 4 shows waveforms of output voltages from the 1/4 bias driving mode LCD drive circuit according to the embodiment of this invention.

FIG. 5 is to explain effects in suppressing noise pulses in the LCD drive circuit according the embodiment of this invention.

FIG. 6 shows a concrete structure of a 1/3 bias driving mode LCD drive circuit according to the embodiment of this invention.

FIG. 7 is a waveform chart showing an example operation of the 1/3 bias driving mode LCD drive circuit according to the embodiment of this invention.

FIG. 8 shows a concrete structure of a 1/4 bias driving mode LCD drive circuit according to the embodiment of this invention.

FIG. 9 is a waveform chart showing an example operation of the 1/4 bias driving mode LCD drive circuit according to the embodiment of this invention.

FIG. 10 shows a structure of an LCD panel.

FIG. 11 is a waveform chart showing an example of common signals and a segment signal in the 1/3 driving mode.

FIG. 12 shows a structure of a 1/3 bias driving mode LCD drive circuit according to a prior art.

FIG. 13 is to explain pulse noises in the LCD panel in the 1/3 bias driving mode.

FIG. 14 is to explain pulse noises in the LCD panel in the 1/3 bias driving mode.

### DETAILED DESCRIPTION OF THE INVENTION

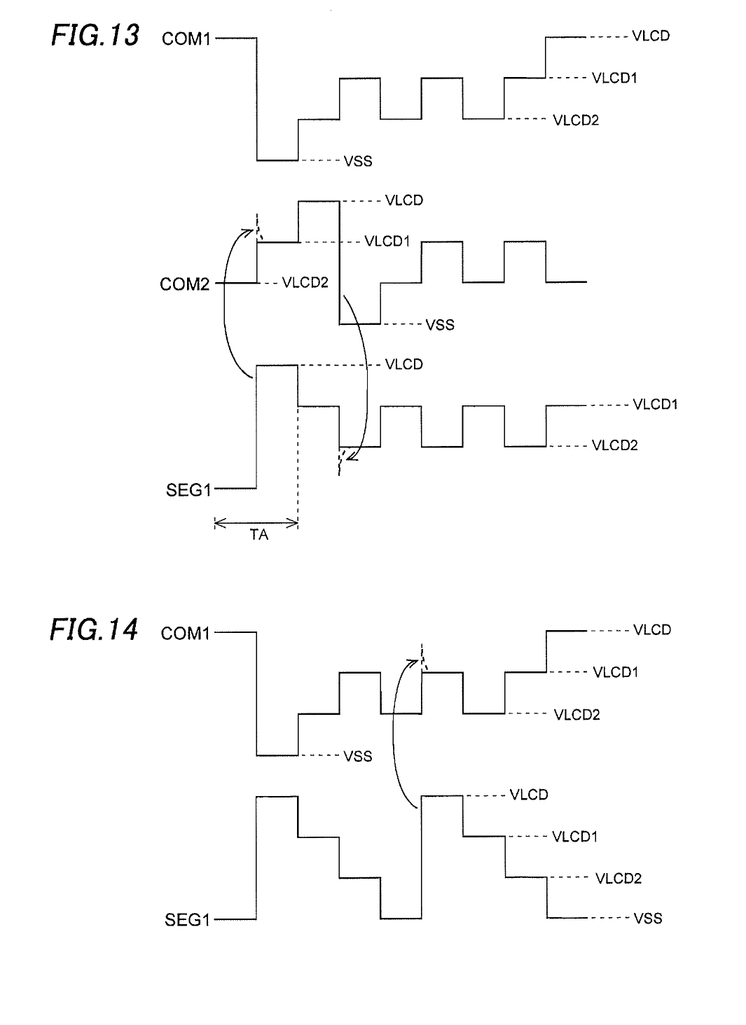

Before describing an LCD drive circuit according to an embodiment of this invention, cases in which the pulse noises are apt to be caused in the LCD panel 12 are studied, taking the 1/3 bias driving mode as an example. For example, there is considered a case in which the common signals COM1 and COM2 and the segment signal SEG1 as shown in FIG. 13 are applied to the LCD panel 12. In this case, the common signal COM1 varies from the high electric potential VLCD to the low electric potential VSS (=the ground electric potential 0V) while the segment signal SEG1 varies from the low electric potential VSS to the high electric potential VLCD on the contrary during a period TA. As a result, an electric potential difference between corresponding electrodes becomes VLCD, and the segment SEG1 facing to the common signal COM1 is turned on.

The common signal COM2 varies from the second intermediate electric potential VLCD2 to the first intermediate electric potential VLCD1 during the period TA. Since the segment signal SEG1 rises from the low electric potential VSS to the high electric potential VLCD at the same time, a pulse noise is caused in the common signal COM2. This is because the common electrode to which the common signal COM2 is applied and the segment electrode to which the segment signal SEG1 is applied are connected by capacitive coupling as described above. Similarly, a pulse noise is caused in the segment signal SEG1 when the common signal COM2 falls from the high electric potential VLCD to the low electric potential VSS.

FIG. 14 shows waveforms of another case in which a pulse noise is caused. In this case, the pulse noise is caused in the common signal COM1 when the segment signal SEG1 varies from the low electric potential VSS to the high electric potential VLCD and the common signal COM1 varies from the second intermediate electric potential VLCD2 to the first intermediate electric potential VLCD1.

To summarize the cases described above, the pulse noise leading to the display failure opt to be caused when one of the common signal COMi and the segment signal SEGj varies by the maximum amplitude between the high electric potential VLCD and the low electric potential VSS while the other is at the first intermediate electric potential VLCD1 or at the second intermediate electric potential VLCD2. This is because the first intermediate electric potential VLCD1 and the second intermediate electric potential VLCD2 are generated by dividing the power supply electric potential with the first bias resistor VR1, the second bias resistor VR2 and the third bias resistor VR3, and thus the intermediate electric potentials VLCD1 and VLCD2 are less stable compared with the high electric potential VLCD or the low electric potential VSS.

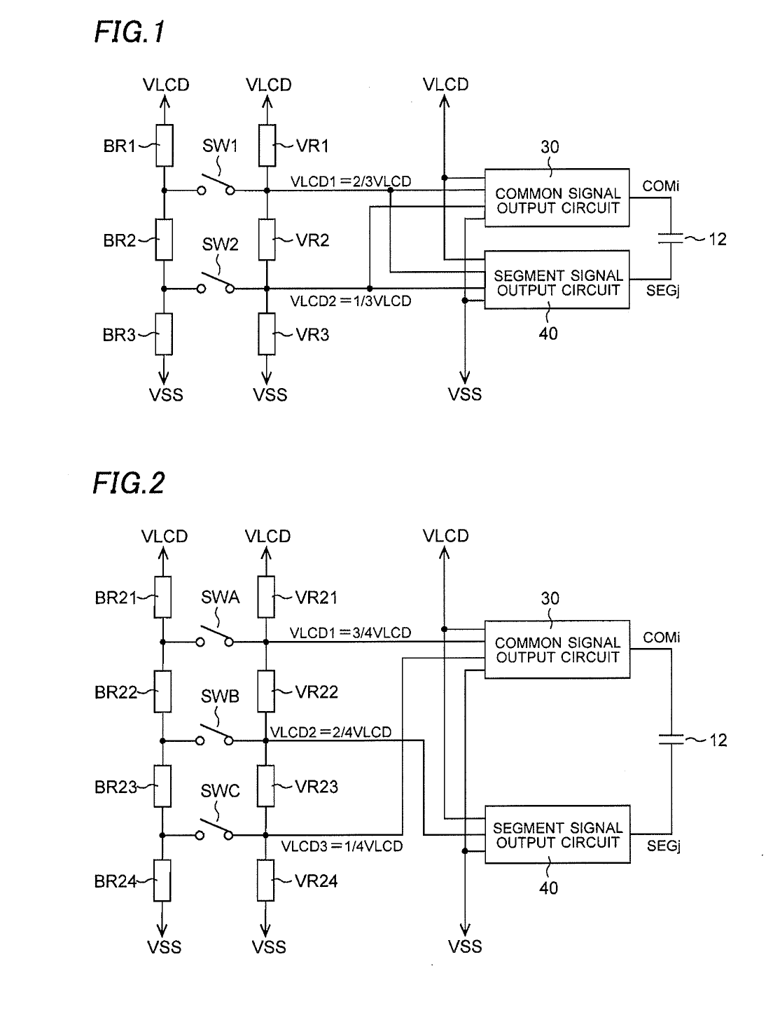

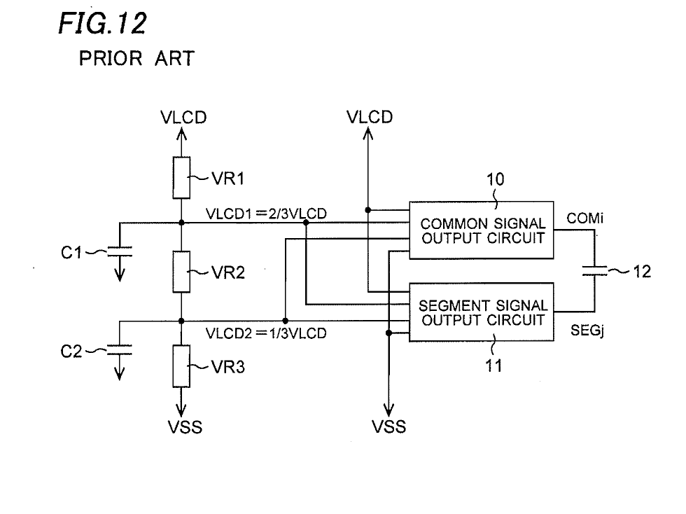

Based on the studies described above, the LCD drive circuit according to the embodiment of this invention will be explained. FIG. 1 shows a structure of a circuit block in the LCD drive circuit, which generates a common signal COMi and a segment signal SEGj in the 1/3 bias driving mode. The same symbols are assigned to components common to those shown in FIG. 12. A first bias resistor VR1, a second bias resistor VR2 and a third bias resistor VR3 are connected in series between a wiring to feed a high electric potential VLCD (5 V, for example) and a wiring to feed a low electric potential VSS (0 V, for example) so as to generate a first intermediate electric potential VLCD1 (=2/3 VLCD) and a second intermediate electric potential VLCD2 (=1/3 VLCD), as shown in FIG. 1. Resistances of the first bias resistor VR1, the second bias resistor VR2 and the third bias resistor VR3 are equal to each other.

Then the first intermediate electric potential VLCD1 is generated at a connecting node between the first bias resistor VR1 and the second bias resistor VR2, while the second intermediate electric potential VLCD2 is generated at a connecting node between the second bias resistor VR2 and the third bias resistor VR3.

Also, a first boost resistor BR1, a second boost resistor BR2 and a third boost resistor BR3 are connected in series between the wiring to feed the high electric potential VLCD and the wiring to feed the low electric potential VSS. Resistances of the first boost resistor BR1, the second boost resistor BR2 and the third boost resistor BR3 are equal to each other. One end of a first switch SW1 is connected to the connecting node between the first bias resistor VR1 and the second bias resistor VR2 while another end of the first switch SW 1 is connected to a connecting node between the first boost resistor BR1 and the second boost resistor BR2.

Also, one end of a second switch SW2 is connected to the connecting node between the second bias resistor VR2 and the third bias resistor VR3 while another end of the second switch SW2 is connected to a connecting node between the second boost resistor BR2 and the third boost resistor BR3. When the first switch SW1 is switched on, corresponding two connecting nodes are short-circuited. When the second switch SW2 is switched on, corresponding two connecting nodes are short-circuited. As a result, the first intermediate electric potential VLCD1 and the second intermediate electric potential VLCD2 are provided through low impedance.

Since the first boost resistor BR1, the second boost resistor BR2 and the third boost resistor BR3 are provided in order to output the first intermediate electric potential VLCD1 and the second intermediate electric potential VLCD2 through low impedance as described above, it is preferable that they have lower resistance than the first bias resistor VR1, the second bias resistor VR2 and the third bias resistor VR3. For example, the resistance of the first boost resistor BR1, the second boost resistor BR2 and the third boost resistor BR3 is 3 KΩ, while the resistance of the first bias resistor VR1, the second bias resistor VR2 and the third bias resistor VR3 is 30 KΩ.

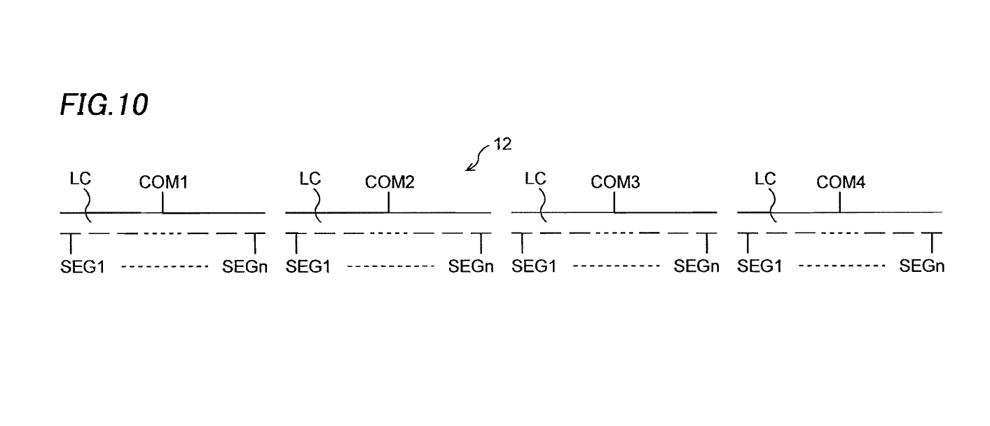

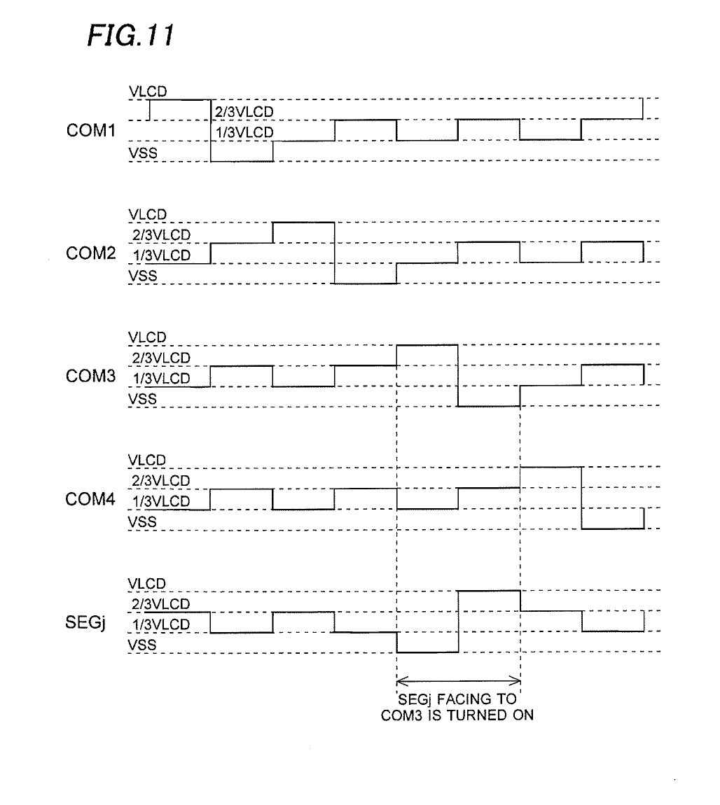

The high electric potential VLCD, the low electric potential VSS, the first intermediate electric potential VLCD1 and the second intermediate electric potential VLCD2 are inputted to a common signal output circuit 30 and a segment signal output circuit 40. The common signal output circuit 30 outputs the common signal COMi made of the four electric potentials VLCD, VSS, VLCD1 and VLCD2, while the segment signal output circuit 40 outputs the segment signal SEGj made of the four electric potentials VLCD, VSS, VLCD1 and VLCD2. The common signal COMi and the segment signal SEGj are applied to the LCD panel 12 as shown in FIGS. 1 and 10.

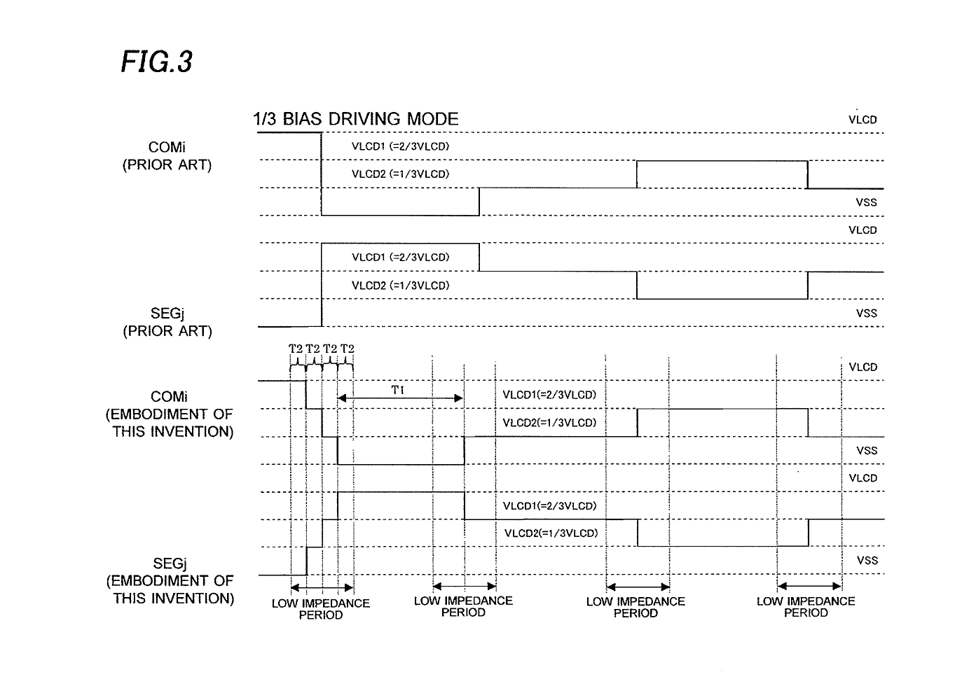

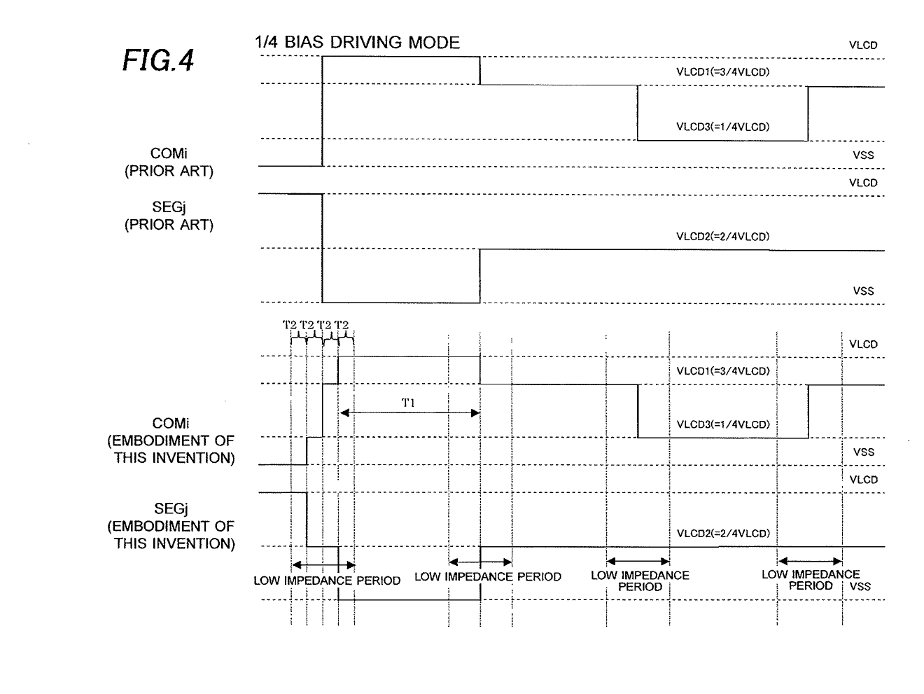

The LCD drive circuit has two principal features as shown in FIGS. 3 and 4. The features are explained regarding the 1/3 bias driving mode that is shown in FIG. 3. The first feature is that the common signal COMi is varied in a staircase waveform with an increment of 1/3 VLCD in such a way that the high electric potential VLCD→the first intermediate electric potential VLCD1→the second intermediate electric potential VLCD2→the low electric potential VSS, when the common signal COMj varies by the maximum amplitude, in other words, when the common signal COMi makes a transition from the high electric potential VLCD to the low electric potential VSS.

In general, the common signal COMi has both a period during which it varies from the high electric potential VLCD to the low electric potential VSS (VLCD→VSS) and a subsequent period during which it alternates between the first intermediate electric potential VLCD1 and the second intermediate electric potential VLCD2 (VLCD2→VLCD1→VLCD2→ . . . ). The liquid crystal LC is turned on during the former period by varying the segment signal SEGj from the low electric potential VSS to the high electric potential VLCD. The liquid crystal LC is turned off during the latter period. The first feature is that the common signal COMi is varied in a staircase waveform with an increment of 1/3 VLCD in the former period.

The same applies to the segment signal SEGj. That is, the segment signal SEGj is varied in a staircase waveform with an increment of 1/3 VLCD in such a way that the high electric potential VLCD→the first intermediate electric potential VLCD1→the second intermediate electric potential VLCD2→the low electric potential VSS, when the segment signal SEGj varies by the maximum amplitude, in other words, when the segment signal SEGj makes a transition from the high electric potential VLCD to the low electric potential VSS. The segment signal SEGj has a period during which it reversely varies from the low electric potential VSS to the high electric potential VLCD. At that time, the segment signal SEGj is varied in such a way that the low electric potential VSS→the second intermediate electric potential VLCD2→the first intermediate electric potential VLCD1→the high electric potential VLCD.

A peak value of the pulse noise due to the capacitive coupling mentioned above can be reduced to one third of that in the prior art by making the amplitude of the common signal COMi and the segment signal SEFj one third of the maximum amplitude as described above.

The 1/4 bias driving mode LCD drive circuit is structured as shown in FIG. 2. The circuit shown in FIG. 2 differs from the circuit shown in FIG. 1 in that there are four bias resistors VR21, VR22, VR23 and VR24 and four boost resistors BR21, BR22, BR23 and BR24. In addition, there are three switches SWA, SWB and SWC. As a result, there are generated three intermediate electric potentials VLCD1 (=3/4 VLCD), VLCD2 (=2/4 VLCD) and VLCD3 (=1/4 VLCD). The same effect obtained by the circuit shown in FIG. 1 is expected with the circuit shown in FIG. 2 by varying the common signal COMi and the segment signal SEGj as shown in FIG. 4.

That is, when the common signal COMi varies from VSS to VLCD, the common signal COMi is varied in a staircase waveform in such a way that VSS→VLCD3→VLCD1→VLCD. At that time, the segment signal SEGj is varied from VLCD to VSS via the intermediate electric potential VLCD2 in such a way that VLCD→VLCD2→VSS. After that, there comes a period during which the liquid crystal LC is turned off. The common signal COMi alternates between VLCD1 and VLCD3 while the segment signal is fixed at VLCD2 during the period. That is, COMi repeats inversions centered around the electric potential of SEGj.

Although FIG. 4 shows a case in which the common signal COMi or the segment signal SEGj is varied by an increment of 1/4 VLCD as well as a case in which the common signal COMi or the segment signal SEGj is varied by an increment of 2/4 VLCD, the increment of the change in the voltages may be unified to 1/4 VLCD at all timings of the changes in the voltages. In that case, a size of the circuit would increase.

According to experiments conducted by the inventors, it is preferable that T2=T1/(20−200), that is, T2 is in a range between 1/20-1/200 of T1 (T2 is equal to or smaller than 1/20 of T1 and equal to or larger than 1/200 of T1), where T1 is a duration of a period during which one of the common signal COMi and the segment signal SEGj is at the high electric potential VLCD and the other is at the low electric potential VSS (a display period during which the liquid crystal LC is turned on) and T2 is a duration of a period during which the common signal COMi or the segment signal SEGj stays at the first intermediate electric potential VLCD1 or at the second intermediate electric potential VLCD2 when the common signal COMi and the segment signal SEGi are varied in the staircase waveform as shown in FIG. 3.

T2 is about 30 microseconds, for example. It is because the effect of suppressing the peak value of the pulse noise is reduced if T2 is too short, and because a current dissipation is increased and a turn-on period of the liquid crystal becomes so short as to cause a display failure if T2 is too long. The correlation between T1 and T2 is similar in the case shown in FIG. 4. It should be noted that T2 is a duration of a period during which the common signal COMi stays at VLCD1 or VLCD3 in the case shown in FIG. 4.

The second feature is that the common signal COMi and the segment signal SEGj are temporarily outputted with low impedance when the electric potentials of the common signal COMi and the segment signal SEGj vary. That is, there are provided low impedance periods in FIG. 3 and in FIG. 4. In order to provide the low impedance periods, the switches SW1 and SW2 are turned on in the 1/3 bias driving mode LCD drive circuit shown in FIG. 1.

Or, the switches SWA, SWB and SWC are turned on in the 1/4 bias driving mode LCD drive circuit shown in FIG. 2.

As a result, the common signal COMi and the segment signal SEGj can be generated from their sources of the resistors with low impedance, and output impedances of the common signal output circuit 30 and the segment signal output circuit 40 that output the signals are also reduced.

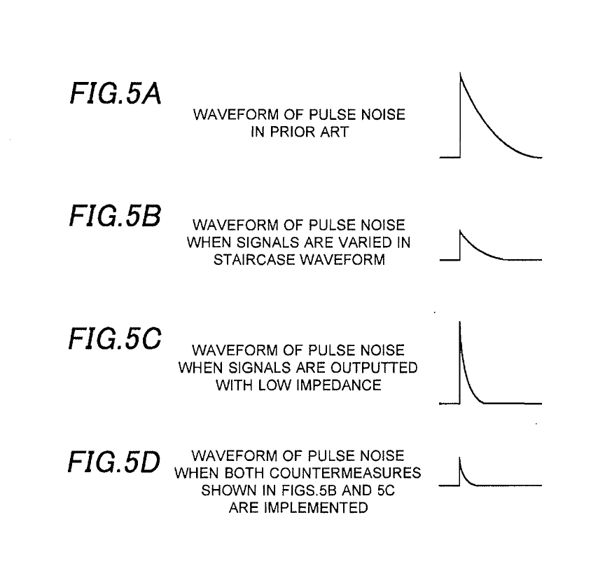

The effects of the first and second features in suppressing the pulse noise will be explained referring to FIGS. 5A, 5B, 5C and 5D, taking the 1/3 bias driving mode LCD drive circuit as an example. The effect of the first feature: When the common signal COMi and the segment signal SEGj are varied in the staircase waveform, the peak value of the pulse noise is reduced as shown in FIG. 5B to 1/3 of the peak value of the pulse noise in the prior art shown in FIG. 5A.

The effect of the second feature: When the common signal COMi and the segment signal SEGj are outputted with low impedance, a width of the pulse noise is reduced, although the peak value remains the same. With both effects of the first and second features, both the peak value and the width of the pulse noise are suppressed as shown in FIG. 5D.

When either of the first and second features is implemented, the LCD drive circuit according to the embodiment of this invention provides the effect corresponding to the feature implemented. And it provides both the effect of suppressing the peak value of the pulse noise and the effect of suppressing the width of the pulse noise when both the first and second features are implemented.

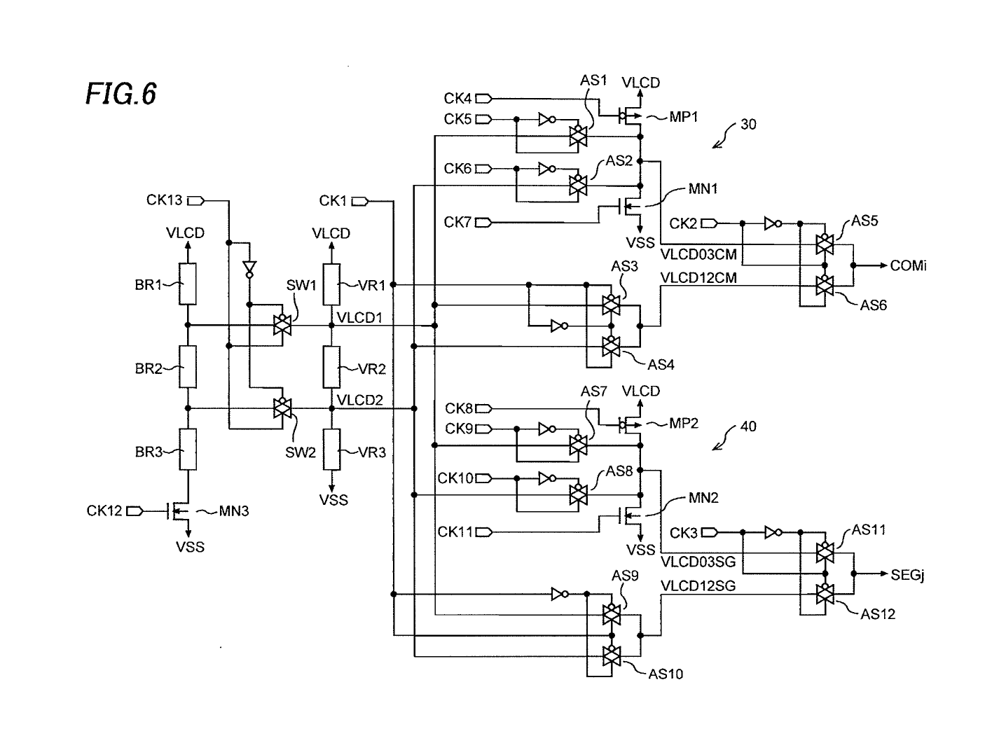

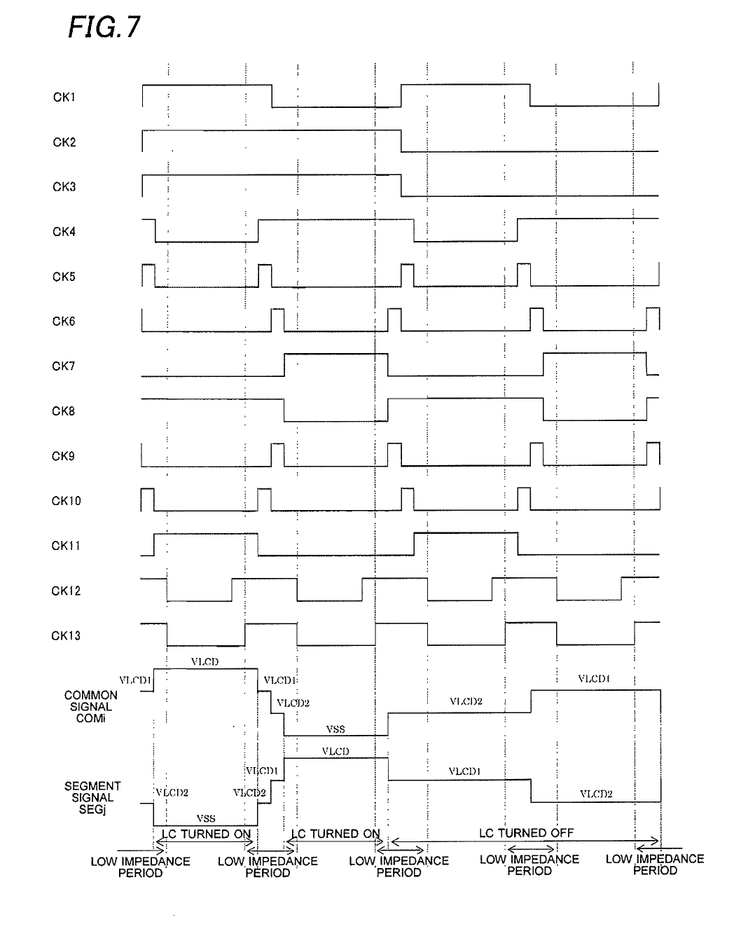

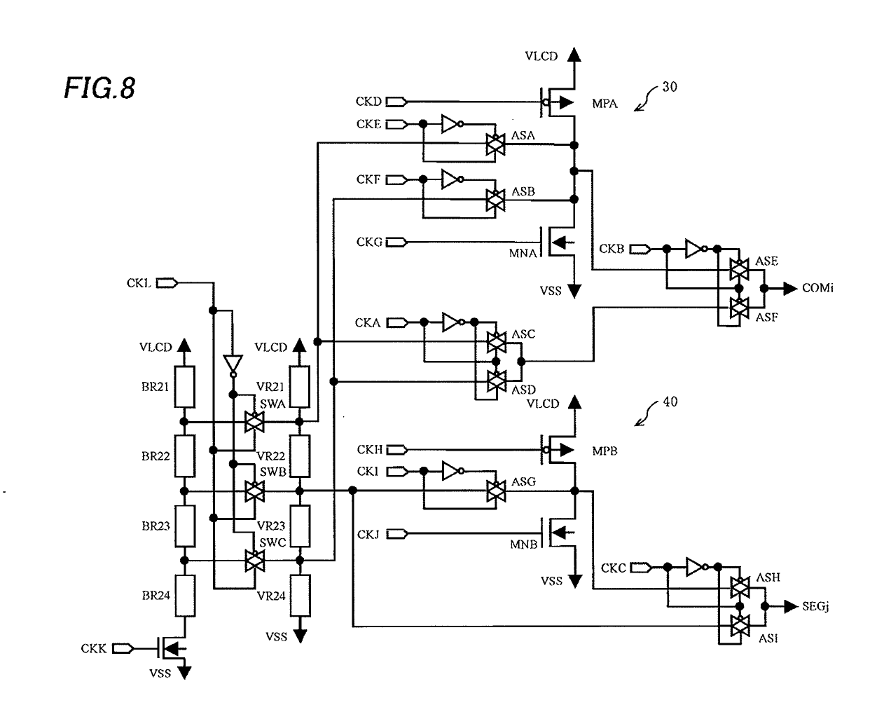

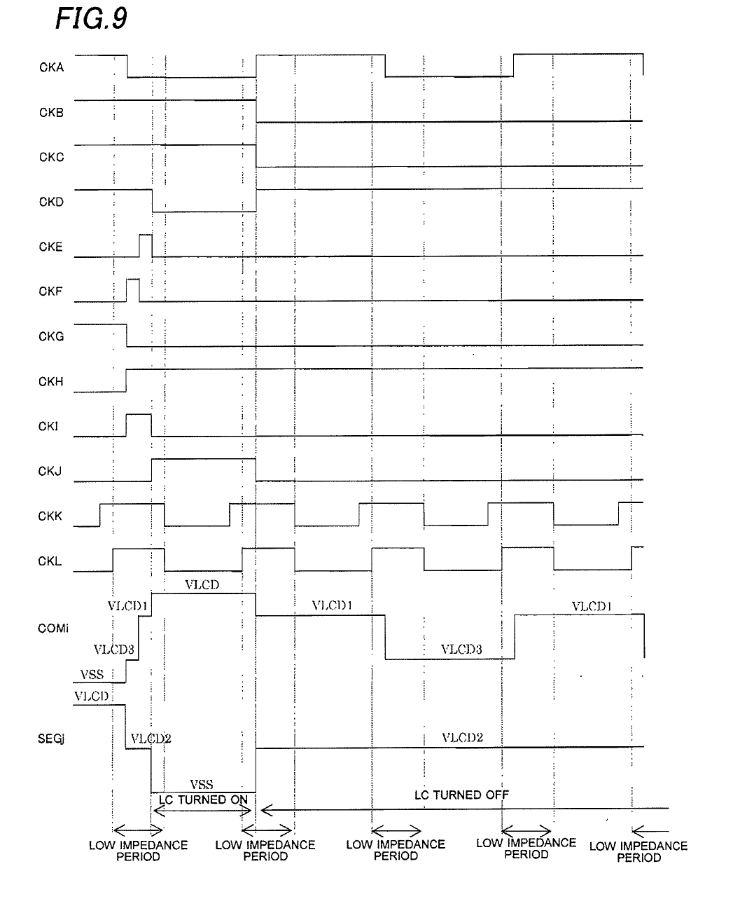

Next, concrete structures and operations of the LCD drive circuit will be described. FIG. 6 shows a circuit structure of the 1/3 bias driving mode LCD drive circuit. FIG. 7 shows drive signals in the 1/3 bias driving mode. FIG. 8 shows a circuit structure of the 1/4 bias driving mode LCD drive circuit. FIG. 9 shows drive signals in the 1/4 bias driving mode. Explanations are given taking the 1/3 bias driving mode LCD drive circuit as an example.

The first switch SW1 and the second switch SW2 are made of analog switches in the resistor circuit to generate the first intermediate electric potential VLCD1 and the second intermediate electric potential VLCD2, as shown in FIG. 6. The first switch SW1 and the second switch SW2 are structured to be turned on when a clock CK13 is at an H level (high electric potential VLCD).

An NMOS transistor (N channel type MOS transistor) MN3 is connected in series to the first, second and third boost resistors BR1, BR2 and BR3. A clock CK12 is applied to a gate of the NMOS transistor MN3 that is turned on when the clock CK12 is at the H level. It is to prevent an unnecessary current from flowing when the first, second and third boost resistors BR1, BR2 and BR3 are not in use so that the power consumption is reduced.

Next, a structure of the common signal output circuit 30 is described. The circuit is made of three blocks. The first block selectively outputs one of the four electric potentials that are the high electric potential VLCD, the first intermediate electric potential VLCD1, the second intermediate electric potential VLCD2 and the low electric potential VSS. The first block is used to vary the common signal COMi in the staircase waveform when the common signal COMi varies by the maximum amplitude that is VLCD.

The first block has a PMOS transistor (P channel type MOS transistor) MP 1 and an NMOS transistor MN1 connected in series to MP1. The high electric potential VLCD is applied to a source of the PMOS transistor MP1, while a clock CK4 is applied to its gate. The low electric potential VSS is applied to a source of the NMOS transistor MN1, while a clock CK7 is applied to its gate.

When the clock CK4 is at an L level (low electric potential VSS), the PMOS transistor MP1 is turned on to output the high electric potential VLCD. When the clock CK7 is at the H level (high electric potential VLCD), the NMOS transistor MN1 is turned on to output the low electric potential VSS.

Two analog switches AS1 and AS2 are connected to a connecting node between the PMOS transistor MP1 and the NMOS transistor MN1. The analog switch AS1 is controlled by a clock CK5 to turn on or off, and outputs the first intermediate electric potential VLCD1 to the connecting node when the clock CK5 is at the H level. The analog switch AS2 is controlled by a clock CK6 to turn on or off, and outputs the second intermediate electric potential VLCD2 to the connecting node when the clock CK6 is at the H level.

The second block is composed of two analog switches AS3 and AS4 that are controlled to turn on complementarily to each other in response to a clock CK1. The second block is in operation in a non-display period during which the first intermediate electric potential VLCD1 and the second intermediate electric potential VLCD2 are outputted alternately. The analog switch AS3 controls outputting of the first intermediate electric potential VLCD1 while the analog switch AS4 controls outputting of the second intermediate electric potential VLCD2.

The third block is composed of two analog switches AS5 and AS6 that are controlled to turn on complementarily to each other in response to a clock CK2. An output signal VLCD03CM from the first block is inputted to the analog switch AS5, while an output signal VLCD12CM from the second block is inputted to the analog switch AS6.

That is, the analog switch AS5 is turned on to output the output signal VLCD03CM from the first block as the common signal COMi when the clock CK2 is at the H level (high electric potential VLCD), and the analog switch AS6 is turned on to output the output signal VLCD12CM from the second block as the common signal COMi when the clock CK2 is at the L level (low electric potential VSS).

The segment signal output circuit 40 has a circuit structure similar to that of the common signal output circuit 30. That is, the segment signal output circuit 40 is made of three blocks. The first block selectively outputs one of the four electric potentials that are the high electric potential VLCD, the first intermediate electric potential VLCD1, the second intermediate electric potential VLCD2 and the low electric potential VSS. The first block is used to vary the segment signal SEGj in the staircase waveform when the segment signal SEGj varies by the maximum amplitude that is VLCD.

The first block has a PMOS transistor MP2 and an NMOS transistor MN2 connected in series to MP2. The high electric potential VLCD is applied to a source of the PMOS transistor MP2, while a clock CK8 is applied to its gate. The low electric potential VSS is applied to a source of the NMOS transistor MN2, while a clock CK11 is applied to its gate. When the clock CK8 is at the L level (low electric potential VSS), the PMOS transistor MP2 is turned on to output the high electric potential VLCD. When the clock CK11 is at the H level (high electric potential VLCD), the NMOS transistor MN2 is turned on to output the low electric potential VSS.

Two analog switches AS7 and AS8 are connected to a connecting node between the PMOS transistor MP2 and the NMOS transistor MN2. The analog switch AS7 is controlled by a clock CK9 to turn on or off, and outputs the first intermediate electric potential VLCD1 to the connecting node when the clock CK9 is at the H level. The analog switch AS8 is controlled by a clock CK10 to turn on or off, and outputs the second intermediate electric potential VLCD2 to the connecting node when the clock CK10 is at the H level.

The second block is composed of two analog switches AS9 and AS10 that are controlled to turn on complementarily to each other in response to the clock CK1. The analog switch AS9 controls outputting of the first intermediate electric potential VLCD1 while the analog switch AS10 controls outputting of the second intermediate electric potential VLCD2.

The third block is composed of two analog switches AS11 and AS 12 that are controlled to turn on complementarily to each other in response to a clock CK3. An output signal VLCD03SG from the first block is inputted to the analog switch AS11, while an output signal VLCD12SG from the second block is inputted to the analog switch AS12.

That is, the analog switch AS11 is turned on to output the output signal VLCD03SG from the first block as the segment signal SEGj when the clock CK3 is at the H level, and the analog switch AS12 is turned on to output the output signal VLCD12SG from the second block as the segment signal SEGj when the clock CK3 is at the L level.

FIG. 7 is a waveform chart showing an example operation of the 1/3 bias driving mode LCD drive circuit. FIG. 7 shows waveforms of the clocks CK1-CK13, the common signal COMi and the segment signal SEGj.

A period during which the common signal COMi is at the high electric potential VLCD and the segment signal SEGj is at the low electric potential VSS is a period during which the liquid crystal LC is turned on (that is, a period during which the display is performed), as shown in FIG. 7. After that, the common signal COMi varies from the high electric potential VLCD to the low electric potential VSS while the segment signal SEGj varies from the low electric potential VSS to the high electric potential VLCD. A period after the variation is also a period during which the liquid crystal LC is turned on. The common signal COMi and the segment signal SEGj vary in the staircase waveform when the common signal COMi and the segment signal SEGj vary by the maximum amplitude to turn on the liquid crystal LC. The low impedance period is provided for a period during which the common signal COMi and the segment signal SEGj vary.

The reason to raise the clock CK12 to the H level before the clock CK13 is raised to the H level to turn the switches SW1 and SW2 on as shown in FIG. 7 is to provide the first boost resistor BR1, the second boost resistor BR2 and the third boost resistor BR3 with starting current by turning the MN3 on in advance so that the first intermediate electric potential VLCD1 and the second intermediate electric potential VLCD2 are stabilized.

The 1/4 bias driving mode LCD drive circuit shown in FIG. 8 is structured based on fundamentally the same concept as the 1/3 bias driving mode LCD drive circuit. That is, there are used analog switches ASA, ASB, ASC, ASD, ASE, ASF, ASG, ASH and ASI, clocks CKA, CKB, CKC, CKD, CKE, CKF, CKG, CKH, CKI, CKJ, CKK and CKL, PMOS transistors MPA and MPB and NMOS transistors MNA and MNB in the 1/4 bias driving mode LCD drive circuit. FIG. 9 shows waveforms of the clocks CKA-CKL, the common signal COMi and the segment signal SEGj.

Needless to say, this invention is not limited to the embodiment described above and may be modified within the scope of the invention. For example, although the first intermediate electric potential VLCD1 is set to 2/3 VLCD and the second intermediate electric potential is set to 1/3 VLCD in the embodiment, they are not limited to the above and may be set to other electric potentials as long as they turn off the liquid crystal LC. In this case, ratios among the resistances of the first bias resistor VR1, the second bias resistor VR2, the third bias resistor VR3, the first boost resistor BR1, the second boost resistor BR2 and the third boost resistor BR3 are modified accordingly.

With the LCD drive circuit according to the embodiment of this invention, the pulse noise in the LCD panel can be suppressed to prevent the display failure without increasing the mounting area.

What is claimed is:

1. A liquid crystal display drive circuit that operates in a 1/n bias driving mode, in which n is an integer larger than or equal to two, by providing a common electrode and a segment electrode of a liquid crystal display panel with a common signal and a segment signal, respectively, comprising:
n bias resistors connected in series between a high electric potential and a low electric potential so as to generate (n−1) intermediate electric potentials between the high electric potential and the low electric potential;
a common signal output circuit outputting the common signal, the common signal comprising the high electric potential, the low electric potential and at least one of the (n−1) intermediate electric potentials; and
a segment signal output circuit outputting the segment signal, the segment signal comprising the high electric potential, the low electric potential and at least one of the (n−1) intermediate electric potentials,
wherein the common signal output circuit varies the common signal in a staircase waveform staying for a period at the one of the (n−1) intermediate electric potentials when the common signal makes a transition between the high electric potential and the low electric potential, and the segment signal output circuit varies the segment signal in a staircase waveform staying for a period at the one of the (n−1) intermediate electric potentials when the segment signal makes a transition between the high electric potential and the low electric potential.

2. The liquid crystal display drive circuit of claim 1, wherein the period during which the common signal or the segment signal stays at the one of the (n−1) intermediate electric potentials are smaller than or equal to 1/20 and larger than or equal to 1/200 of a period during which one of the common signal and the segment signal stays at the high electric potential and the other of the common signal and the segment signal stays at the low electric potential.

3. A liquid crystal display drive circuit that operates in a 1/n bias driving mode, in which n is an integer larger than or equal to two, by providing a common electrode and a segment electrode of a liquid crystal display panel with a common signal and a segment signal, respectively, comprising:
n bias resistors connected in series between a high electric potential and a low electric potential so as to generate (n−1) intermediate electric potentials between the high electric potential and the low electric potential;
n boost resistors connected in series between the high electric potential and the low electric potential so as to generate the (n−1) intermediate electric potentials between the high electric potential and the low electric potential;
a common signal output circuit outputting the common signal, the common signal comprising the high electric potential, the low electric potential and at least one of the (n−1) intermediate electric potentials;
a segment signal output circuit outputting the segment signal, the segment signal comprising the high electric potential, the low electric potential and at least one of the (n−1) intermediate electric potentials; and
a switching circuit outputting the one of the (n−1) intermediate electric potentials generated by the n boost resistors to the common signal output circuit and the segment signal output circuit when the common signal or the segment signal varies.

4. The liquid crystal display drive circuit of claim 3, wherein a resistance of the n boost resistors is smaller than a resistance of the n bias resistors.

5. The liquid crystal display drive circuit of claim 3, wherein the switching circuit comprises (n−1) switches each connected between one of (n−1) connecting nodes between an adjacent pair of the bias resistors and one of (n−1) connecting nodes between an adjacent pair of the boost resistors, and wherein the switching circuit turns the (n−1) switches on when the common signal or the segment signal varies.

6. The liquid crystal display drive circuit of claim 4, wherein the switching circuit comprises (n−1) switches each connected between one of (n−1) connecting nodes between an adjacent pair of the bias resistors and one of (n−1) connecting nodes between an adjacent pair of the boost resistors, and wherein the switching circuit turns the (n−1) switches on when the common signal or the segment signal varies.

7. The liquid crystal display drive circuit of claim 3, wherein the common signal output circuit varies the common signal in a staircase waveform staying for a period at the one of the (n−1) intermediate electric potentials when the common signal makes a transition between the high electric potential and the low electric potential, and the segment signal output circuit varies the segment signal in a staircase waveform staying for a period at the one of the (n−1) intermediate electric potentials when the segment signal makes a transition between the high electric potential and the low electric potential.

8. The liquid crystal display drive circuit of claim 4, wherein the common signal output circuit varies the common signal in a staircase waveform staying for a period at the one of the (n−1) intermediate electric potentials when the common signal makes a transition between the high electric potential and the low electric potential, and the segment signal output circuit varies the segment signal in a staircase waveform staying for a period at the one of the (n−1) intermediate electric potentials when the segment signal makes a transition between the high electric potential and the low electric potential.

9. The liquid crystal display drive circuit of claim 5, wherein the common signal output circuit varies the common signal in a staircase waveform staying for a period at the one of the (n−1) intermediate electric potentials when the common signal makes a transition between the high electric potential and the low electric potential, and the segment signal output circuit varies the segment signal in a staircase waveform staying for a period at the one of the (n−1) intermediate electric potentials when the segment signal makes a transition between the high electric potential and the low electric potential.

10. The liquid crystal display drive circuit of claim 6, wherein the common signal output circuit varies the common signal in a staircase waveform staying for a period at the one of the (n−1) intermediate electric potentials when the common signal makes a transition between the high electric potential and the low electric potential, and the segment signal output circuit varies the segment signal in a staircase waveform staying for a period at the one of the (n−1) intermediate electric potentials when the segment signal makes a transition between the high electric potential and the low electric potential.

11. A liquid crystal display drive circuit that makes a display on a liquid crystal display panel by providing a common electrode and a segment electrode of the liquid crystal display panel with a common signal and a segment signal, respectively, comprising:
a first bias resistor, a second bias resistor and a third bias resistor connected in series between a high electric potential and a low electric potential so as to generate a first intermediate electric potential and a second intermediate electric potential between the high electric potential and the low electric potential;
a common signal output circuit outputting the common signal, the common signal comprising the high electric potential, the low electric potential, the first intermediate electric potential and the second intermediate electric potential; and
a segment signal output circuit outputting the segment signal, the segment signal comprising the high electric potential, the low electric potential, the first intermediate electric potential and the second intermediate electric potential,
wherein the common signal output circuit varies the common signal in a staircase waveform staying for a period at the first and second intermediate electric potentials when the common signal makes a transition between the high electric potential and the low electric potential, and the segment signal output circuit varies the segment signal in a staircase waveform staying for a period at the first and second intermediate electric potentials when the segment signal makes a transition between the high electric potential and the low electric potential.

12. The liquid crystal display drive circuit of claim 11, wherein the period during which the common signal or the segment signal stays at the first and second intermediate electric potentials is smaller than or equal to 1/20 and larger than or equal to 1/200 of a period during which one of the common signal and the segment signal stays at the high electric potential and the other of the common signal and the segment signal stays at the low electric potential.

13. A liquid crystal display drive circuit that makes a display on a liquid crystal display panel by providing a common electrode and a segment electrode of the liquid crystal display panel with a common signal and a segment signal, respectively, comprising:
a first bias resistor, a second bias resistor and a third bias resistor connected in series between a high electric potential and a low electric potential so as to generate a first intermediate electric potential and a second intermediate electric potential between the high electric potential and the low electric potential;
a first boost resistor, a second boost resistor and a third boost resistor connected in series between the high electric potential and the low electric potential so as to generate the first intermediate electric potential and the second intermediate electric potential between the high electric potential and the low electric potential;
a common signal output circuit outputting the common signal, the common signal comprising the high electric potential, the low electric potential, the first intermediate electric potential and the second intermediate electric potential;
a segment signal output circuit outputting the segment signal, the segment signal comprising the high electric potential, the low electric potential, the first intermediate electric potential and the second intermediate electric potential; and
a switching circuit to output the first and second intermediate electric potentials generated by the first, second and third boost resistors to the common signal output circuit and the segment signal output circuit when the common signal or the segment signal varies.

14. The liquid crystal display drive circuit of claim 13, wherein each of the first, second and third boost resistors has a smaller resistance than each of the first, second and third bias resistors.

15. The liquid crystal display drive circuit of claim 13, wherein the switching circuit comprises a first switch connected between a connecting node between the first bias resistor and the second bias resistor and a connecting node between the first boost resistor and the second boost resistor and a second switch connected between a connecting node between the second bias resistor and the third bias resistor and a connecting node between the second boost resistor and the third boost resistor, and the switching circuit turns the first and second switches on when the common signal or the segment signal varies.

16. The liquid crystal display drive circuit of claim 14, wherein the switching circuit comprises a first switch connected between a connecting node between the first bias resistor and the second bias resistor and a connecting node between the first boost resistor and the second boost resistor and a second switch connected between a connecting node between the second bias resistor and the third bias resistor and a connecting node between the second boost resistor and the third boost resistor, and the switching circuit turns the first and second switches on when the common signal or the segment signal varies.

17. The liquid crystal display drive circuit of claim 13, wherein the common signal output circuit varies the common signal in a staircase waveform staying for a period at the first and second intermediate electric potentials when the common signal makes a transition between the high electric potential and the low electric potential, and the segment signal output circuit varies the segment signal in a staircase waveform staying for a period at the first and second intermediate electric potentials when the segment signal makes a transition between the high electric potential and the low electric potential.

18. The liquid crystal display drive circuit of claim 14, wherein the common signal output circuit varies the common signal in a staircase waveform staying for a period at the first and second intermediate electric potentials when the common signal makes a transition between the high electric potential and the low electric potential, and the segment signal output circuit varies the segment signal in a staircase waveform staying for a period at the first and second intermediate electric potentials when the segment signal makes a transition between the high electric potential and the low electric potential.

19. The liquid crystal display drive circuit of claim 15, wherein the common signal output circuit varies the common signal in a staircase waveform staying for a period at the first and second intermediate electric potentials when the common signal makes a transition between the high electric potential and the low electric potential, and the segment signal output circuit varies the segment signal in a staircase waveform staying for a period at the first and second intermediate electric potentials when the segment signal makes a transition between the high electric potential and the low electric potential.

20. The liquid crystal display drive circuit of claim 16, wherein the common signal output circuit varies the common signal in a staircase waveform staying for a period at the first and second intermediate electric potentials when the common signal makes a transition between the high electric potential and the low electric potential, and the segment signal output circuit varies the segment signal in a staircase waveform staying for a period at the first and second intermediate electric potentials when the segment signal makes a transition between the high electric potential and the low electric potential.
